(19) United States
(12) Patent Application Publication
(10) Pub. No.: US 2026/0003109 A1
(43) Pub. Date: Jan. 1, 2026

(54) LENS MODULE AND OPTICAL DEVICE

(71) Applicant: Asia Optical Co., Inc., Taichung (TW)

(72) Inventor: MING-WEI SHIH, Taichung (TW)

(21) Appl. No.: 19/226,411

(22) Filed: Jun. 3, 2025

(30) Foreign Application Priority Data
Jun. 27, 2024 (TW) 113124023

(51) Int. Cl. G02B 5/04

(52) U.S. Cl. CPC G02B 5/04

(57) ABSTRACT

A lens module includes an optical prism. The optical prism includes a prism body and at least one recess structure. The prism body includes a first surface, a second surface, a third surface and a fourth surface, wherein the first surface and the third surface are opposite, the second surface and the fourth surface are opposite, the first surface is adjacent to the second surface and the fourth surface, and the third surface is adjacent to the second surface and the fourth surface. A light beam enters the prism body through the first surface, undergoes multiple total internal reflections in the prism body, and leaves the prism body through the fourth surface. The recess structure is formed on the prism body, and extended from the surfaces of the prism body to the interior.

### BACKGROUND OF THE INVENTION

### Field of the Invention

The invention relates to a technical field of optical prism structures, and more particularly to an optical prism and a lens module having the optical prism that is provided with a recess structure to reflect stray light thereby capable of avoiding ghost images, stray light and overlapping images.

### Description of the Related Art

Generally, an optical system is provided with a prism for changing the optical path. As shown in FIG. 1, light L enters a prism through an incident surface O, and is incident on an interface S between the prism and air. If the incident angle of light is greater than a critical angle of a total internal reflection, then a total internal reflection occurs and the light in the prism is changed to travel in another direction (at an angle intersecting the incident angle). Then, the light is emitted from the prism.

In operation, light is totally reflected on the interface S between the prism and air. Because of the shape of the prism that is under restrictions, the prism has some locations U where the reflected light may not follow the designed path to reach the next reflection surface but to directly reach the light-emitting surface T. The light which directly reaches the light-emitting surface T may overlap with the light which travels along the designed path, thereby resulting in overlapping images, commonly known as ghost images, or forming stray light that affects the imaging in the effective optical path.

### BRIEF SUMMARY OF THE INVENTION

The invention provides an optical prism and a lens device having the optical prism to solve the problem of overlapping images arising from stray light in the prism of the prior art.

The lens module in accordance with an exemplary embodiment of the invention includes an optical prism configured to turn an optical path of the lens module. The optical prism includes a prism body and at least one recess structure. The prism body includes a first surface, a second surface, a third surface and a fourth surface, wherein the first surface and the third surface are opposite, the second surface and the fourth surface are opposite, the first surface is adjacent to the second surface and the fourth surface, and the third surface is adjacent to the second surface and the fourth surface. A light beam enters the prism body through the first surface and leaves the prism body through the fourth surface. The recess structure is formed on a surface of the prism body. The recess structure is configured to satisfy at least one of the following conditions: 0.1 mm<A<0.45 mm; 1.4<P/C<7.2; 1.2<C/A<18; 4.8<P/A<40, where A is a width of the recess structure defined as a maximum opening size of the recess structure that is measured along the surface, P is a thickness of the prism body which is a distance measured from the first surface to the third surface, and C is a total depth of the recess structure defined as a maximum depressed size that is measured from the surface to an interior of the prism body; or the recess structure includes a rectangular groove formed on the surface of the prism body and a triangular groove connected to the rectangular groove, the recess structure is configured to satisfy at least one of the following conditions: 5°<B<30°; 1.3<C/D<3.0, where B is a cut angle of the triangular groove, D is a depth of the rectangular groove, and C is a total depth of the recess structure defined as a sum of the depth of the rectangular groove D and that of the triangular groove.

In another exemplary embodiment, the light beam is perpendicularly incident on the first surface, a first reflection of the light beam occurs on the second surface, and an included angle between the first surface and the second surface is an acute angle greater than arcsin (1/n) where n is a refractive index of the prism body.

In yet another exemplary embodiment, the light beam undergoes N total internal reflections in the prism body, and the prism body includes N−1 recess structures where N is a positive integer and N≥2.

In another exemplary embodiment, the light beam undergoes at least one total internal reflection in the prism body. The recess structure is formed on the first surface, the second surface and/or the third surface, and extended to an interior of the prism body. A projected area of the recess structure on the fourth surface has a predetermined length.

In yet another exemplary embodiment, the recess structure includes inner walls which are coated or darkened. The recess structure is disposed corresponding to a total internal reflection occurring on the second surface, the first surface or the third surface. The recess structure is disposed closer to the fourth surface than a corresponding total internal reflection point of the light beam on the first surface, the second surface, or the third surface.

In another exemplary embodiment, the optical prism includes a plurality of recess structures. The recess structures include inner walls which are coated or darkened. The recess structures are disposed corresponding to a first total internal reflection through an (N−1)th total internal reflection which occur on the second surface, the first surface and the third surface. Each of the recess structures is disposed closer to the fourth surface than a corresponding total internal reflection point of the light beam on the first surface, the second surface, or the third surface.

In yet another exemplary embodiment, the prism body further includes two side surfaces disposed opposite to each other. The two side surfaces are connected to the first surface, the second surface, the third surface and the fourth surface to form a substantially trapezoidal prism. The first surface is parallel to the third surface. The second surface and the fourth surface are inclined at same or different angles. The prism body further includes a raised portion connected to the first surface and the fourth surface. The recess structure is laterally extended to the two side surfaces.

An optical device in accordance with an exemplary embodiment of the invention includes the above-mentioned lens module, at least one lens disposed near the first surface, and an image sensor disposed near the fourth surface. The light beam passes through the lens, enters the prism body through the first surface, and leaves the prism body through the fourth surface to form an image on the image sensor.

A lens module in accordance with another exemplary embodiment of the invention includes an optical prism configured to turn an optical path of the lens module. The optical prism includes a prism body and at least one recess structure. The prism body includes a first surface, a second surface, a third surface and a fourth surface, wherein the first surface and the third surface are opposite, the second surface and the fourth surface are opposite, the first surface is adjacent to the second surface and the fourth surface, and the third surface is adjacent to the second surface and the fourth surface. A light beam enters the prism body through the first surface and leaves the prism body through the fourth surface. The recess structure is formed on a surface of the prism body, the recess structure includes a rectangular groove formed on the surface of the prism body and an arc groove connected to the rectangular groove, and a diameter of the arc groove is equal to a width of the recess structure; or the recess structure includes a rectangular groove formed on the surface of the prism body and a triangular groove connected to the rectangular groove, and the triangular groove is extended from the surface to an interior of the prism body so as to form a tapered structure.

In yet another exemplary embodiment, the recess structure is configured to satisfy one or any combination of the following conditions: 5°<B<30°; 1.3<C/D<3.0, where B is a cut angle of the triangular groove, D is a depth of the rectangular groove, and C is a total depth of the recess structure defined as a sum of the depth of the rectangular groove and that of the triangular groove.

In another exemplary embodiment, the recess structure is configured to satisfy at least one of the following conditions: 0.1 mm<A<0.45 mm; 1.4<P/C<7.2; 1.2<C/A<18; 4.8<P/A<40, 5°<B<30°; 1.3<C/D<3.0; 0.05 mm<A<0.25 mm, where A is a width of the recess structure defined as a maximum opening size of the recess structure that is measured along the surface, P is a thickness of the prism body which is a distance measured from the first surface to the third surface, C is a total depth of the recess structure defined as a maximum depressed size that is measured from the surface to an interior of the prism body, B is a cut angle of the triangular groove, and D is a depth of the rectangular groove.

In yet another exemplary embodiment, a radius of the arc groove is less than 0.15 mm.

In the invention, the recess structures are provided on the first surface, the second surface and/or the third surface of the prism body. The projection of the recess structure on the fourth surface has a predetermined length. Therefore, the light reflected at certain positions on the first surface, the second surface and/or the third surface will not reach the light emitting surface but is blocked or absorbed by the recess structures so as to avoid the problem of overlapping images.

### BRIEF DESCRIPTION OF THE DRAWINGS

FIG. 1 is a perspective view of a conventional optical prism.

FIG. 2 is a perspective view of an optical prism of a lens module in accordance with a first embodiment of the invention.

FIG. 3 is a sectional view of the optical prism of FIG. 2.

FIG. 4 is a sectional view of an optical prism in accordance with a second embodiment of the invention.

FIG. 5 is a partial enlarged view of FIG. 3 or FIG. 4.

FIG. 6 is a schematic view of an optical device of the invention, showing the optical path of the optical prism of FIG. 3.

FIG. 7 is a schematic view showing the optical path of an optical prism in accordance with a third embodiment of the invention.

FIG. 8 is a perspective view of an optical prism in accordance with a fourth embodiment of the invention.

FIG. 9 is a sectional view of the optical prism of FIG. 8.

FIG. 10 is a sectional view of an optical prism in accordance with a fifth embodiment of the invention.

FIG. 11 is a partial enlarged view of FIG. 9 or FIG. 10.

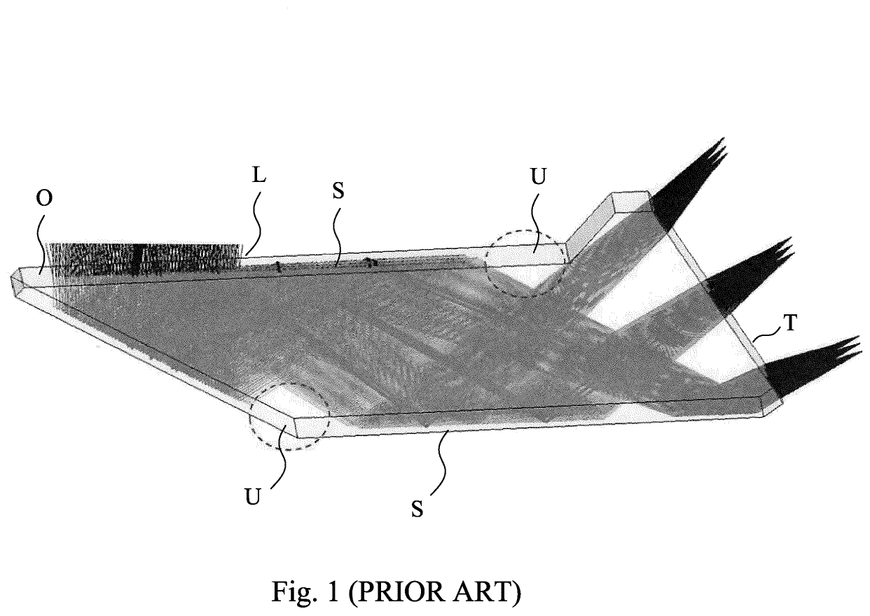

### DETAILED DESCRIPTION OF THE INVENTION

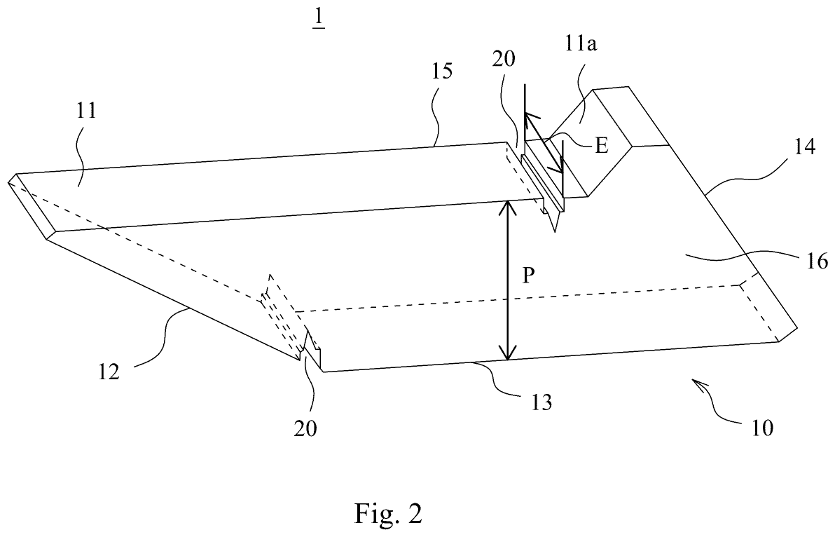

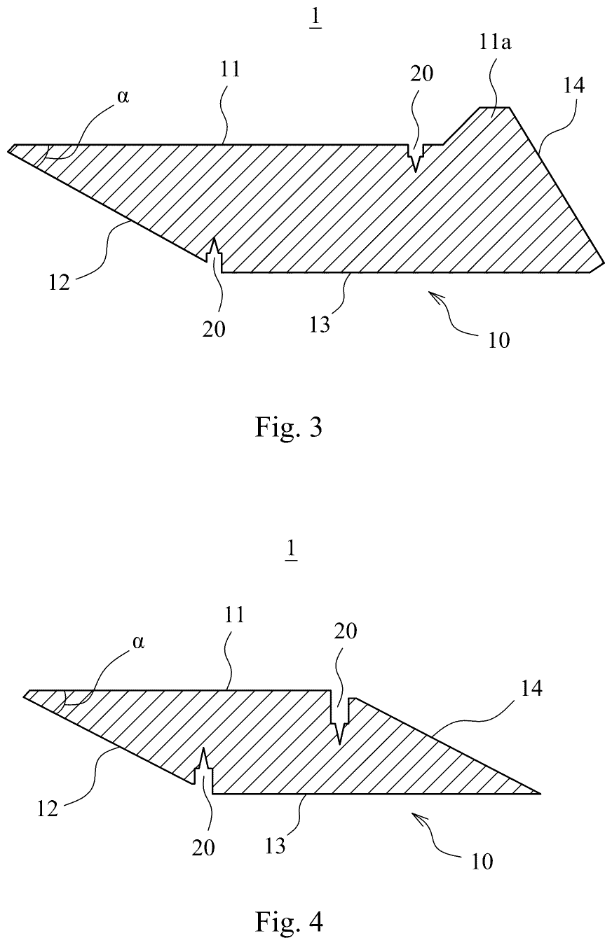

FIGS. 2 and 3 depict an optical prism of a lens module in accordance with a first embodiment of the invention, wherein the optical prism 1 has a prism body 10 and a plurality of recess structures 20. The prism body 10 has a first surface 11, a second surface 12, a third surface 13, a fourth surface 14 and two side surfaces 15, 16. The first surface 11, the second surface 12, the third surface 13, the fourth surface 14 and the two side surfaces 15, 16 are connected to form a substantially trapezoidal prism. Specifically, the first surface 11 and the third surface 13 are disposed opposite to and parallel to each other. The second surface 12 and the fourth surface 14 are disposed opposite to each other. Further, the second surface 12 and the fourth surface 14 are inclined at different angles so that the second surface 12 is not parallel to the fourth surface 14. The invention is not limited thereto. The second surface 12 and the fourth surface 14 may be inclined at the same angle so that the second surface 12 is parallel to the fourth surface 14. The first surface 11 is disposed adjacent to the second surface 12 and the fourth surface 14. The third surface 13 is disposed adjacent to the second surface 12 and the fourth surface 14. The two side surfaces 15, 16 are disposed opposite to each other and connected to the first surface 11, the second surface 12, the third surface 13, and the fourth surface 14. In this embodiment, the fourth surface 14 has an enlarged area so as to increase the light-emitting area. Therefore, a raised portion 11a is formed between the first surface 11 and the fourth surface 14 and protrudes from the first surface 11.

Referring to FIG. 6, in operation, a light beam L from an object side passes through at least one lens LN, enters the prism body 10 through the first surface 11, undergoes N total internal reflections on the second surface 12, the first surface 11 and the third surface 13 in sequence, and leaves the prism body 10 through the fourth surface 14 to form an image on an image sensor IS. In this embodiment, N is a positive integer and N≥2. That is, the light beam L undergoes at least two total internal reflections in the prism body 10. The number of lenses LN is at least one, namely there is one lens, two lenses, or more lenses. The light beam L is perpendicularly incident on the first surface 11. To ensure that the first total internal reflection occurs on the second surface 12, an included angle α between the first surface 11 and the second surface 12 is designed to be an acute angle greater than arcsin (1/n) where n is a refractive index of the prism body 10. The material of the prism body 10 is glass, the refractive index of which is 1.5. The included angle α between the first surface 11 and the second surface 12 is greater than 41.8°. After totally reflected on the second surface 12, the light beam L undergoes other total internal reflections on the first surface 11 and the third surface 13 which are disposed in parallel. By means of the total internal reflections, the light beam L is able to travel in the prism body 10 along a designed optical path. Then, the light beam L is emitted from the fourth surface 14 and leaves the prism body 10 so as to form an image on the image sensor IS. In this embodiment, the light beam L undergoes three total internal reflections inside the prism body 10.

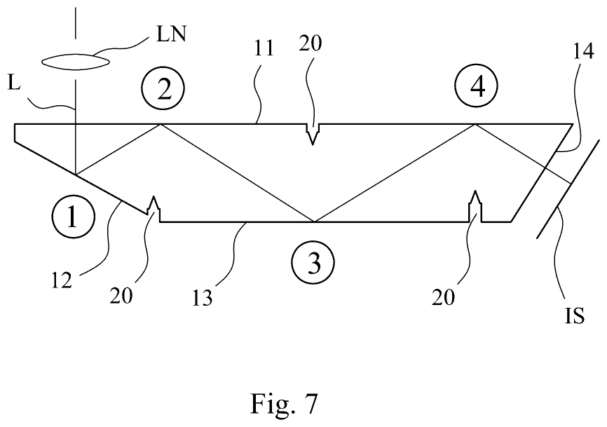

As described, the light beam L undergoes N reflections on the second surface 12, the first surface 11 and the third surface 13. After the last reflection, the light beam L is emitted from the fourth surface 14. Besides, the prism body 10 is provided with plural recess structures 20. By such arrangement, the problem of overlapping images caused by stray light can be avoided. In detail, not only the first reflection of the light beam L on the second surface 12 but the subsequent reflections of the light beam L between the first surface 11 and the third surface 13 may generate stray light (the stray light may arise from the light reflections at certain positions) which is able to directly reach the fourth surface 14 to form overlapping images. The prism body 10 is therefore provided with N−1 recess structures 20 corresponding to the first total internal reflection through the Nth total internal reflection. In FIG. 6, the light beam L undergoes three total internal reflections, namely N=3. The prism body 10 has two recess structures 20 on the second surface 12 and the first surface 11, namely (N−1)=(3−1)=2. In FIG. 7, the light beam L undergoes four total internal reflections, namely N=4. The prism body 10 has three recess structures 20 on the second surface 12, the first surface 11 and the third surface 13, namely (N−1)=(4−1)=3. In brief, the light beam L undergoes N total internal reflections in the prism body 10, and the prism body 10 is correspondingly provided with N−1 recess structures wherein N is a positive integer and N≥2. If the number of the recess structures is determined in accordance with the above design, then the fourth surface (light emitting surface) 14 can be avoided from the stray light, the problems of ghost images or stray light can be avoided, and good imaging quality can be obtained.

Each recess structure 20 extends from the first surface 11, the second surface 12, or the third surface 13 into the interior of the prism body 10. Further, each recess structure 20 is disposed closer to the fourth surface 14 than the corresponding total internal reflection point of the light beam L on the first surface 11, the second surface 12, or the third surface 13. The projected area of the recess structure 20 on the fourth surface 14 has a predetermined length. The inner walls of the recess structure 20 are coated or darkened. When the light beam L is reflected at some locations to generate stray light, the stray light can be blocked, reflected or absorbed by the recess structure 20 which is disposed in the optical path of the stray light so that the stray light cannot reach the fourth surface 14. Therefore, the problems of ghost images or stray light or the problems of overlapping images arising from the stray light in the prior art can be solved. As long as the effective optical path is not blocked, the location of the recess structure 20 on the prism body 10 can be adjusted according to the requirements of the optical system in which the lens LN is provided to cooperate with the prism body 10.

FIG. 4 depicts an optical prism in accordance with a second embodiment of the invention, wherein the elements of the second embodiment same as those of the first embodiment are indicated by the same reference numerals and the descriptions thereof are omitted. The second embodiment differs from the first embodiment in that the fourth surface 14 and the second surface 12 of the second embodiment are arranged in parallel. By such arrangement, the included angle between the fourth surface 14 and the first surface 11 is increased, and the fourth surface 14 has an increased area (the light emitting area is increased). Besides, the first surface 11 of the prism body 10 of the second embodiment is not provided with the raised portion.

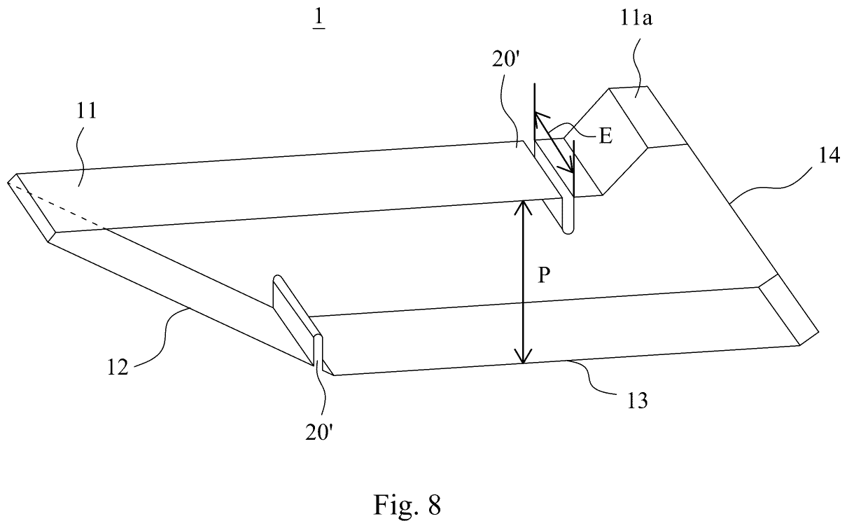

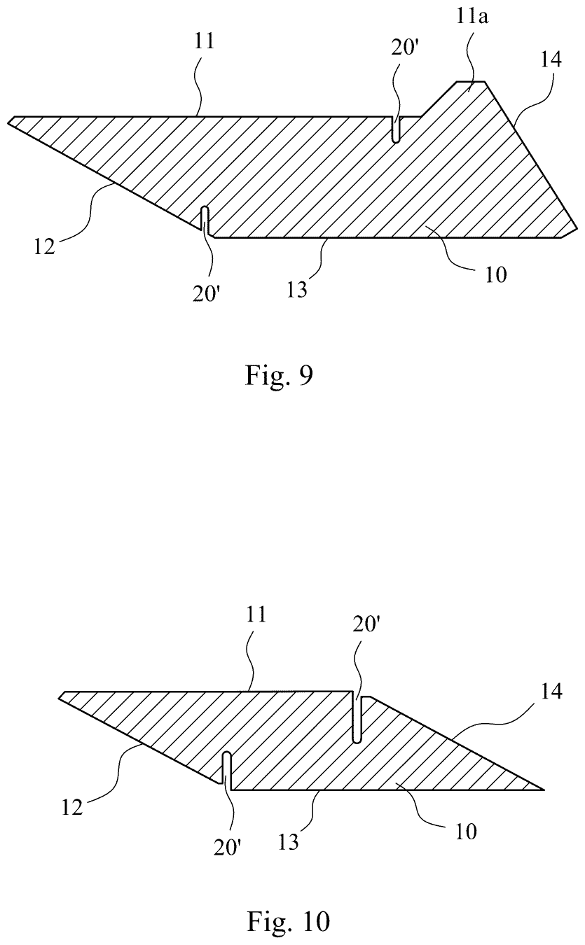

FIG. 7 depicts an optical prism in accordance with a third embodiment of the invention, wherein the elements of the third embodiment same as those of the first embodiment are indicated by the same reference numerals and the descriptions thereof are omitted. The third embodiment differs from the first embodiment in that, in the third embodiment, an angle between the fourth surface 14 and the first surface 11 is an acute angle, and an angle between the fourth surface 14 and the third surface 13 is an obtuse angle. By such arrangement, the length of the first surface 11 is increased, and the total internal reflections of the light beam L in the prism body 10 are therefore increased. In the third embodiment, the light beam L undergoes four total internal reflections in the prism body 10. In operation, the light beam L enters the prism body 10 through the first surface 11, reaches the second surface 12 where a first total internal reflection occurs, is reflected to the first surface 11 where a second total internal reflection occurs, reaches the third surface 13 where a third total internal reflection occurs, is reflected to the first surface 11 where a fourth total internal reflection, and leaves the prism body 10 through the fourth surface 14 to form an image on the image sensor IS. In some other embodiments, a raised portion may be provided on the third surface 13 to increase the light emitting area of the fourth surface 14. A part of or all of the recess structures 20 of the third embodiment may be replaced with the recess structures 20′ of FIG. 8 through FIG. 10. The prism body 10 in accordance with the configuration of the third embodiment can still effectively block the ghost images or the stray light by using the recess structures.

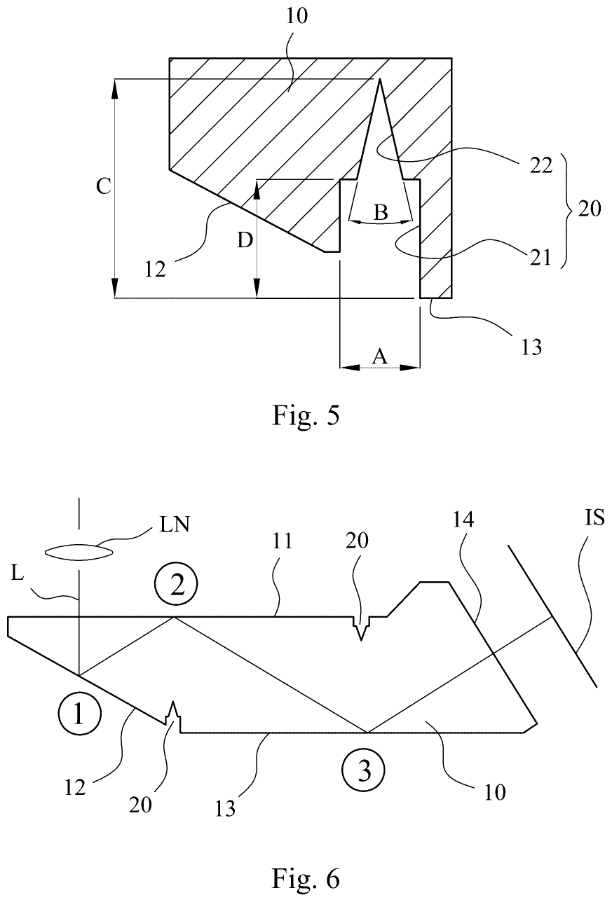

FIG. 5 is an enlarged view of a recess structure 20 of FIGS. 2-4 and FIGS. 6-7. As shown, the recess structure 20 has a length E, a width A and a total depth C, where A is the maximum opening size of the recess structure that is measured along any one surface of the prism body 10, for example, the first surface 11, the second surface 12 or the third surface 13; C is the maximum depressed size that is measured from any one surface of the prism body 10, for example, the first surface 11, the second surface 12 or the third surface 13 to an interior of the prism body 10; and E is a length of the recess structure 20 measured from the side surface 15 to the side surface 16. The prism body 10 has a thickness P which is a distance measured from the first surface 11 to the third surface 13. Referring to FIG. 2, the length E of each recess structure 20 is equal to the thickness P of the prism body 10. It is understood that the length E of each recess structure 20 may be different from the thickness P of the prism body 10. As shown in FIG. 5, in the invention, the maximum opening size A of the recess structure 20 is ranged between 0.1 mm and 0.45 mm, namely 0.1 mm<A<0.45 mm. The ratio of the thickness P of the prism body 10 to the total depth C of the recess structure 20 is ranged between 1.4 and 7.2, namely 1.4<P/C<7.2. For example, P/C=2.72 mm/1.23 mm=2.21, 2.72 mm/1.46 mm=1.86, 2.72 mm/1.03 mm=2.64, 3.32 mm/0.89 mm=3.73, 3.32 mm/0.71 mm=4.68, 4.3 mm/0.89 mm=4.83, or 4.3 mm/0.71 mm=6.06. The ratio of the total depth C of the recess structure 20 to the width A is ranged between 1.2 and 18, namely 1.2<C/A<18. For example, C/A=1.23 mm/0.1 mm=12.3, 1.23 mm/0.45 mm=2.73, 1.46 mm/0.1 mm=14.6, 1.46 mm/0.45 mm=3.24, 1.03 mm/0.1 mm=10.3, 1.03 mm/0.45 mm=2.29, 0.89 mm/0.1 mm=8.9, 0.89 mm/0.45 mm=1.98, 0.71 mm/0.1 mm=7.1, or 0.71 mm/0.45 mm=1.58. The ratio of the thickness P of the prism body 10 to the width A of the recess structure 20 is ranged between 4.8 and 40, namely 4.8<P/A<40. For example, P/A=2.72 mm/0.1 mm=27.2, 2.72 mm/0.45 mm=6.04, 3.32 mm/0.1 mm=33.2, or 3.32 mm/0.45 mm=7.38. In other words, each recess structure satisfies at least one of the following conditions: 0.1 mm<A<0.45 mm, 1.4<P/C<7.2, 1.2<C/A<18, and 4.8<P/A<40. Besides, the recess structure 20 has a length E which is equal to a measurement from the side surface 15 to the side surface 16. If the above conditions and arrangement are satisfied, then the stray light in the prism body 10 can be effectively blocked, the image sensor IS can be avoided from the undesired light, and the problems of the ghost images and the stray light generated in the prism body 10 of the lens module can be significantly improved.

As shown in FIG. 5, the recess structure 20 of the first embodiment through the third embodiment has a rectangular groove 21 and a triangular groove 22. The rectangular groove 21 is disposed adjacent to the first surface 11, the second surface 12 or the third surface 13. However, the invention is not limited thereto. The rectangular groove 21 may be formed on any surface of the prism body 10. The triangular groove 22 is connected to the rectangular groove 21. The triangular groove 22 is perpendicularly extended from the first surface 11, the second surface 12 or the third surface 13 to the interior of the prism body 10 so as to form a tapered structure. In other words, the triangular groove 22 is extended from any surface of the prism body 10 to the interior so as to form a tapered structure. The triangular groove 22 has a cut angle B. The rectangular groove 21 has a depth D. The recess structure 20 has a total depth C defined as the sum of the depth D of the rectangular groove 21 and that of the triangular groove 22. The cut angle B of the triangular groove 22 is ranged between 5° and 30°, namely 5°<B<30°. The ratio of the total depth D of the recess structure 20 to the depth D of the rectangular groove 21 is ranged between 1.3 and 3.0, namely 1.3<C/D<3.0. For example, C/D=1.23 mm/0.67 mm=1.84, 1.46 mm/0.86 mm=1.70, 0.89 mm/0.47 mm=1.89, or 0.71 mm/0.29 mm=2.45. In other words, each recess structure further satisfies at least one of the following conditions: 5°<B<30° and 1.3<C/D<3.0. If the above conditions and arrangement are satisfied, then the recess structure can be effectively formed on the prism body in the manufacturing process so as to effectively block the stray light and to avoid the ghost images.

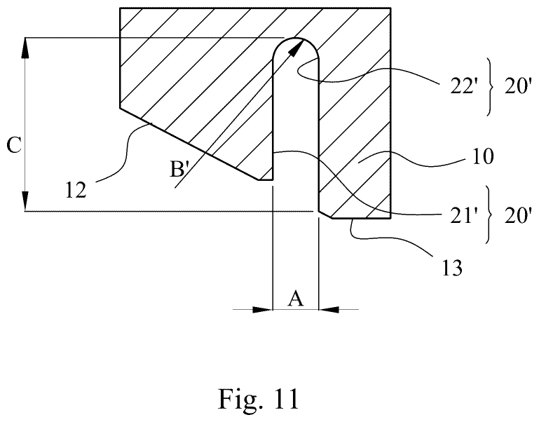

FIGS. 8, 9 and 11 depict an optical prism in accordance with a fourth embodiment of the invention, wherein the elements of the fourth embodiment same as those of the first embodiment are indicated by the same reference numerals and the descriptions thereof are omitted. The fourth embodiment differs from the first embodiment in that the recess structure 20′ of the fourth embodiment has a rectangular groove 21′ and an arc groove 22′. The rectangular groove 21′ is disposed adjacent to the first surface 11, the second surface 12 or the third surface 13. However, the invention is not limited thereto. The rectangular groove 21′ may be formed on any surface of the prism body 10. The arc groove 22′ is connected to the rectangular groove 21′. The diameter of the arc groove 22′ is equal to the width A of the recess structure 20′. Specifically, the recess structure 20′ of the fourth embodiment is a unitary body with a cylindrical hole formed therein. The recess structure 20′ has an open end disposed distant from the interior of the prism body 10, and a bottom end disposed opposite to the open end and towards the interior of the prism body 10. The arc groove 22′ is formed at the bottom end of the recess structure 20′. In the fourth embodiment, the width A of the recess structure 20′ is ranged between 0.05 mm and 0.45 mm, namely 0.05 mm<A<0.45 mm. Preferably, 0.05 mm<A<0.25 mm. As shown in FIG. 11, the radius B′ of the arc groove 22′ is ranged between 0.05 mm and 0.15 mm, namely 0.05 mm<B′<0.15 mm, that is, the radius value B′ of the cylindrical shape formed in the arc groove 22′ is within the range. The ratio of the thickness P of the prism body 10 to the total depth C of the recess structure 20′ is ranged between 1.4 and 7.2, namely 1.4<P/C<7.2. For example, P/C=2.72 mm/1.23 mm=2.21, 2.72 mm/1.46 mm=1.86, 2.72 mm/1.03 mm=2.64, 3.32 mm/0.89 mm=3.73, 3.32 mm/0.71 mm=4.68, 4.3 mm/0.89 mm=4.83, or 4.3 mm/0.71 mm=6.06. The ratio of the total depth C of the recess structure 20′ to the width A is ranged between 1.2 and 18, namely 1.2<C/A<18. For example, C/A=1.23 mm/0.1 mm=12.3, 1.23 mm/0.45 mm=2.73, 1.46 mm/0.1 mm=14.6, 1.46 mm/0.45 mm=3.24, 1.03 mm/0.1 mm=10.3, 1.03 mm/0.45 mm=2.29, 0.89 mm/0.1 mm=8.9, 0.89 mm/0.45 mm=1.98, 0.71 mm/0.1 mm=7.1, 0.71 mm/0.45 mm=1.58. The ratio of the thickness P of the prism body 10 to the width A of the recess structure 20′ is ranged between 4.8 and 40, namely 4.8<P/A<40. For example, P/A=2.72 mm/0.1 mm=27.2, 2.72 mm/0.45 mm=6.04, 3.32 mm/0.1 mm=33.2, or 3.32 mm/0.45 mm=7.38. In other words, each recess structure 20′ satisfies at least one of the following conditions: 0.1 mm<A<0.45 mm; 0.05 mm<A<0.25 mm; 0.05 mm<B′<0.15 mm; 1.4<P/C<7.2; 1.2<C/A<18; and 4.8<P/A<40. If the above conditions and arrangement are satisfied, then the stray light in the prism body 10 can be effectively blocked, the image sensor IS can be avoided from the undesired light, and the problems of the ghost images and the stray light generated in the prism body 10 of the lens module can be significantly improved.

FIG. 10 depicts an optical prism in accordance with a fifth embodiment of the invention, wherein the elements of the fifth embodiment same as those of the second embodiment are indicated by the same reference numerals and the descriptions thereof are omitted. The fifth embodiment differs from the second embodiment in that the recess structure 20′ of the fifth embodiment has a rectangular groove 21′ and an arc groove 22′. The rectangular groove 21′ is disposed adjacent to the first surface 11, the second surface 12 or the third surface 13. However, the invention is not limited thereto. The rectangular groove 21′ may be formed on any surface of the prism body 10. The arc groove 22′ is connected to the rectangular groove 21′. The diameter of the arc groove 22′ is equal to the width A of the recess structure 20′. Specifically, the recess structure 20′ of the fifth embodiment is a unitary body with a cylindrical hole formed therein. The recess structure 20′ has an open end disposed distant from the interior of the prism body 10, and a bottom end disposed opposite to the open end and towards the interior of the prism body 10. The arc groove 22′ is formed at the bottom end of the recess structure 20′. Each recess structure 20′ satisfies at least one of the following conditions: 0.1 mm<A<0.45 mm; 0 mm<B′<0.15 mm; 1.4<P/C<7.2; 1.2<C/A<18; and 4.8<P/A<40.

The fifth embodiment differs from the second embodiment in the recess structure 20′. The fifth embodiment and the fourth embodiment have the same recess structure 20′. The fifth embodiment differs from the fourth embodiment in the outward shape of the prism body 10. The outward shape of the prism body 10, as well as the positions and number of the recess structures, can be adjusted and replaced according to actual requirement. That is, the outward shape of the prism body 10 can be changed to meet the requirements of different optical systems in which different lenses are included. Besides, the prism body has recess structures disposed in appropriate positions and therefore the number of recess structures is corresponding determined (e.g. one, two, three or more recess structures are provided). By such arrangement, the problems of the ghost images and stray light of the prior art can be solved.

In the invention, the recess structures are provided on the first surface, the second surface and/or the third surface of the prism body (or on any surfaces of the prism body). The inner walls of each recess structure are coated or darkened. The projection of the recess structure on the fourth surface has a predetermined length. Therefore, the light reflected at certain positions on the first surface, the second surface and/or the third surface will not reach the light emitting surface but is blocked or absorbed by the recess structures so as to avoid the problem of overlapping images.

In each of the embodiments of the invention, the recess structures of the prism body may have the same structure and size or a combination of different structures and sizes, and the outward shapes of the recess structures may be changed in accordance with the practical requirements.

What is described above is only the preferred embodiment of the invention, and the scope of the invention is not limited thereto. That is, the simple equivalent changes and modifications made according to the description of the invention and the claims are all within the scope of the invention. Further, any one of the embodiments or claims is not required to achieve all the objects or advantages or features of the invention. Further, the abstract and title are only used to assist in the search of patent documents and are not intended to limit the scope of the invention.

What is claimed is:

1. A lens module comprising:
an optical prism configured to turn an optical path of the lens module;
wherein the optical prism comprises a prism body and at least one recess structure;
wherein the prism body comprises a first surface, a second surface, a third surface and a fourth surface, wherein the first surface and the third surface are opposite, the second surface and the fourth surface are opposite, the first surface is adjacent to the second surface and the fourth surface, and the third surface is adjacent to the second surface and the fourth surface;
wherein a light beam enters the prism body through the first surface and leaves the prism body through the fourth surface;
wherein the recess structure is formed on a surface of the prism body;
wherein the recess structure is configured to satisfy at least one of the following conditions:
$$0.1 mm < A < 0.45 mm ;$$
$$1.4 < P / C < 7.2 ;$$
$$1.2 < C / A < 18 ;$$
$$4.8 < P / A < 40 ,$$
where A is a width of the recess structure defined as a maximum opening size of the recess structure that is measured along the surface, P is a thickness of the prism body which is a distance measured from the first surface to the third surface, and C is a total depth of the recess structure defined as a maximum depressed size that is measured from the surface to an interior of the prism body; or
wherein the recess structure comprises a rectangular groove formed on the surface of the prism body and a triangular groove connected to the rectangular groove, the recess structure is configured to satisfy at least one of the following conditions:
$$5 ° < B < 30 ° ;$$
$$1.3 < C / D < 3. ,$$
where B is a cut angle of the triangular groove, D is a depth of the rectangular groove, and C is a total depth of the recess structure defined as a sum of the depth of the rectangular groove D and that of the triangular groove.

2. The lens module as claimed in claim 1, wherein the light beam is perpendicularly incident on the first surface, a first reflection of the light beam occurs on the second surface, and an included angle between the first surface and the second surface is an acute angle greater than arcsin (1/n) where n is a refractive index of the prism body.

3. The lens module as claimed in claim 1, wherein the light beam undergoes N total internal reflections in the prism body, and the prism body comprises N−1 recess structures where N is a positive integer and N≥2.

4. The lens module as claimed in claim 1, wherein:
the light beam undergoes at least one total internal reflection in the prism body;
the recess structure is formed on the first surface, the second surface and/or the third surface, and extended to an interior of the prism body;
a projected area of the recess structure on the fourth surface has a predetermined length.

5. The lens module as claimed in claim 1, wherein:
the recess structure comprises inner walls which are coated or darkened;
the recess structure is disposed corresponding to a total internal reflection occurring on the second surface, the first surface or the third surface;
the recess structure is disposed closer to the fourth surface than a corresponding total internal reflection point of the light beam on the first surface, the second surface, or the third surface.

6. The lens module as claimed in claim 1, wherein:
the optical prism comprises a plurality of recess structures;
the recess structures comprise inner walls which are coated or darkened;
the recess structures are disposed corresponding to a first total internal reflection through an (N−1)th total internal reflection which occur on the second surface, the first surface and the third surface;
each of the recess structures is disposed closer to the fourth surface than a corresponding total internal reflection point of the light beam on the first surface, the second surface, or the third surface.

7. The lens module as claimed in claim 1, wherein:
the prism body further comprises two side surfaces disposed opposite to each other;
the two side surfaces are connected to the first surface, the second surface, the third surface and the fourth surface to form a substantially trapezoidal prism;
the first surface is parallel to the third surface;
the second surface and the fourth surface are inclined at same or different angles;
the prism body further comprises a raised portion connected to the first surface and the fourth surface;
the recess structure is laterally extended to the two side surfaces.

8. An optical device, comprising:
the lens module as claimed in claim 1;
at least one lens disposed near the first surface;
an image sensor disposed near the fourth surface;
wherein the light beam passes through the lens, enters the prism body through the first surface, and leaves the prism body through the fourth surface to form an image on the image sensor.

9. A lens module comprising:
an optical prism configured to turn an optical path of the lens module;
wherein the optical prism comprises a prism body and at least one recess structure;
wherein the prism body comprises a first surface, a second surface, a third surface and a fourth surface, wherein the first surface and the third surface are opposite, the second surface and the fourth surface are opposite, the first surface is adjacent to the second surface and the fourth surface, and the third surface is adjacent to the second surface and the fourth surface;
wherein a light beam enters the prism body through the first surface and leaves the prism body through the fourth surface;
wherein the recess structure is formed on a surface of the prism body, the recess structure comprises a rectangular groove formed on the surface of the prism body and an arc groove connected to the rectangular groove, and a diameter of the arc groove is equal to a width of the recess structure; or
wherein the recess structure comprises a rectangular groove formed on the surface of the prism body and a triangular groove connected to the rectangular groove, and the triangular groove is extended from the surface to an interior of the prism body so as to form a tapered structure.

10. The lens module as claimed in claim 9, wherein the recess structure is configured to satisfy one or any combination of the following conditions:
$$5 ° < B < 30 ° ;$$
$$1.3 < C / D < 3. ,$$
where B is a cut angle of the triangular groove, D is a depth of the rectangular groove, and C is a total depth of the recess structure defined as a sum of the depth of the rectangular groove and that of the triangular groove.

11. The lens module as claimed in claim 9, wherein the recess structure is configured to satisfy at least one of the following conditions:
$$0.1 mm < A < 0.45 mm ;$$
$$1.4 < P / C < 7.2 ;$$
$$1.2 < C / A < 18 ;$$
$$4.8 < P / A < 40 ,$$
$$5 ° < B < 30 ° ;$$
$$1.3 < C / D < 3. ;$$
$$0.05 mm < A < 0.25 mm ,$$
where A is a width of the recess structure defined as a maximum opening size of the recess structure that is measured along the surface, P is a thickness of the prism body which is a distance measured from the first surface to the third surface, C is a total depth of the recess structure defined as a maximum depressed size that is measured from the surface to an interior of the prism body, B is a cut angle of the triangular groove, and D is a depth of the rectangular groove.

12. The lens module as claimed in claim 11, wherein a radius of the arc groove is less than 0.15 mm.

13. The lens module as claimed in claim 9, wherein the light beam is perpendicularly incident on the first surface, a first reflection of the light beam occurs on the second surface, and an included angle between the first surface and the second surface is an acute angle greater than arcsin (1/n) where n is a refractive index of the prism body.

14. The lens module as claimed in claim 9, wherein the light beam undergoes N total internal reflections in the prism body, and the prism body comprises N−1 recess structures where N is a positive integer and N≥2.

15. The lens module as claimed in claim 9, wherein:
the light beam undergoes at least one total internal reflection in the prism body;
the recess structure is formed on the first surface, the second surface and/or the third surface, and extended to an interior of the prism body;
a projected area of the recess structure on the fourth surface has a predetermined length.

16. The lens module as claimed in claim 9, wherein:
the recess structure comprises inner walls which are coated or darkened;
the recess structure is disposed corresponding to a total internal reflection occurring on the second surface, the first surface or the third surface;
the recess structure is disposed closer to the fourth surface than a corresponding total internal reflection point of the light beam on the first surface, the second surface, or the third surface.

17. The lens module as claimed in claim 9, wherein:
the optical prism comprises a plurality of recess structures;
the recess structures comprise inner walls which are coated or darkened;
the recess structures are disposed corresponding to a first total internal reflection through an (N−1)th total internal reflection which occur on the second surface, the first surface and the third surface;
each of the recess structures is disposed closer to the fourth surface than a corresponding total internal reflection point of the light beam on the first surface, the second surface, or the third surface.

18. The lens module as claimed in claim 9, wherein:
the prism body further comprises two side surfaces disposed opposite to each other;
the two side surfaces are connected to the first surface, the second surface, the third surface and the fourth surface to form a substantially trapezoidal prism;
the first surface is parallel to the third surface;
the second surface and the fourth surface are inclined at same or different angles;
the prism body further comprises a raised portion connected to the first surface and the fourth surface;
the recess structure is laterally extended to the two side surfaces.

19. An optical device, comprising:
the lens module as claimed in claim 9;
at least one lens disposed near the first surface;
an image sensor disposed near the fourth surface;
wherein the light beam passes through the lens, enters the prism body through the first surface, and leaves the prism body through the fourth surface to form an image on the image sensor.
